(19) United States
(12) Patent Application Publication
(10) Pub. No.: US 2024/0310634 A1
(43) Pub. Date: Sep. 19, 2024

(54) DISPLAY DEVICE

(71) Applicant: Japan Display Inc., Tokyo (JP)

(72) Inventors: Yasuhiro TAKAHASHI, Tokyo (JP); Shinichi KOMURA, Tokyo (JP); Jin HIROSAWA, Tokyo (JP)

(73) Assignee: Japan Display Inc., Tokyo (JP)

(21) Appl. No.: 18/605,855

(22) Filed: Mar. 15, 2024

(30) Foreign Application Priority Data
Mar. 17, 2023 (JP) 2023-043212

(51) Int. Cl. G02B 27/01; G02B 5/30; G02F 1/1335; G02F 1/13357; G02F 1/13363

(52) U.S. Cl. CPC G02B 27/0172; G02B 5/3016; G02B 5/3083; G02B 6/0068; G02F 1/133524; G02F 1/133615; G02F 1/133638; G02B 2027/0105; G02B 2027/0136; G02B 2027/0174

(57) ABSTRACT

According to one embodiment, a display device includes a display module configured to emit display light which is linearly polarized light, a first retardation film, a holographic optical element which is configured to reflect first circularly polarized light having a specific incident angle and transmit light having an incident angle which is different from the specific incident angle, a second retardation film, a reflective polarizer which is configured to reflect first linearly polarized light and transmit second linearly polarized light, a third retardation film, and a lens element which has a lens effect of condensing first circularly polarized light and converting first circularly polarized light into second circularly polarized light.

### CROSS-REFERENCE TO RELATED APPLICATION

This application is based upon and claims the benefit of priority from Japanese Patent Application No. 2023-043212, filed Mar. 17, 2023, the entire contents of which are incorporated herein by reference.

### FIELD

Embodiments described herein relate generally to a display device.

### BACKGROUND

In recent years, technology which uses a head-mounted display worn on the head of a user and provides, for example, virtual reality (VR) has been drawing attention. The head-mounted display is configured to display an image on a display provided in front of the eyes of the user. By this configuration, the user who wears the head-mounted display can experience a virtual reality space with realism.

### BRIEF DESCRIPTION OF THE DRAWINGS

FIG. 1 is a perspective view showing an example of the external appearance of a head-mounted display 1.

FIG. 2 is a diagram for explaining the outline of the configuration of the head-mounted display 1 shown in FIG. 1.

FIG. 3 is a cross-sectional view showing a configuration example of a display device DSP.

FIG. 4 is a plan view showing the display device DSP shown in FIG. 3.

FIG. 5 is a cross-sectional view showing an example of the lens element LE shown in FIG. 3.

FIG. 6 is a plan view showing an example of the alignment pattern in the liquid crystal layer LC1 shown in FIG. 5.

FIG. 7 is a diagram for explaining an example of the optical effect of the display device DSP shown in FIG. 3.

### DETAILED DESCRIPTION

Embodiments described herein aim to provide a display device which can prevent the reduction in display quality.

In general, according to one embodiment, a display device comprises a display module configured to emit display light which is linearly polarized light, a first retardation film which faces the display module, a holographic optical element which faces the first retardation film and is configured to reflect first circularly polarized light having a specific incident angle and transmit light having an incident angle which is different from the specific incident angle, a second retardation film which faces the holographic optical element, a reflective polarizer which faces the second retardation film and is configured to reflect first linearly polarized light and transmit second linearly polarized light, a third retardation film which faces the reflective polarizer, and a lens element which faces the third retardation film and has a lens effect of condensing first circularly polarized light and converting first circularly polarized light into second circularly polarized light.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. The plane defined by the X-axis and the Y-axis is referred to as an X-Y plane. When the X-Y plane is viewed, the appearance is defined as a plan view.

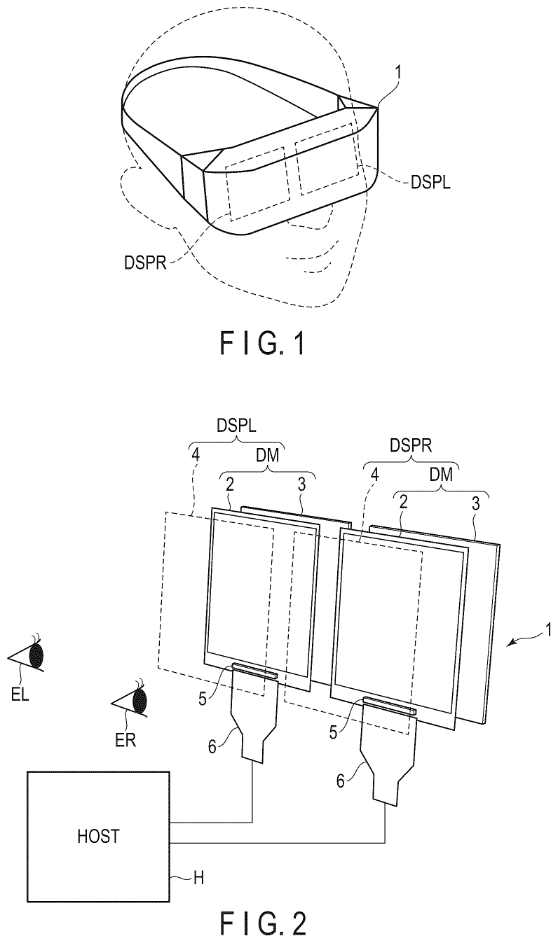

FIG. 1 is a perspective view showing an example of the external appearance of a head-mounted display 1.

The head-mounted display 1 comprises, for example, a display device DSPR for the right eye and a display device DSPL for the left eye. In a state where the user wears the head-mounted display 1 on the head, the display device DSPR is provided to be located in front of the right eye of the user, and the display device DSPL is provided to be located in front of the left eye of the user.

FIG. 2 is a diagram for explaining the outline of the configuration of the head-mounted display 1 shown in FIG. 1.

The display device DSPR is configured in substantially the same manner as the display device DSPL. Each of the display device DSPR and the display device DSPL comprises a display module DM and an optical system 4 shown by dotted lines. The display module DM is configured to emit display light which is linearly polarized light. The optical system 4 of the display device DSPR is configured to guide the display light from the display module DM to the right eye ER. The optical system 4 of the display device DSPL is configured to guide the display light from the display module DM to the left eye EL.

For example, the display module DM consists of a display panel 2 and an illumination device 3. The display panel 2 is a liquid crystal panel. The display panel 2 is provided between the illumination device 3 and the optical system 4. The illumination device 3 is provided on the back surface of the display panel 2 and is configured to illuminate the display panel 2.

It should be noted that the configuration of the display module DM is not limited to the example shown in the figure. For example, the display module DM may be a display panel comprising a self-luminous light emitting element such as an organic electroluminescent (EL) element, a micro LED or a mini LED. When the display module DM is a display panel comprising a light emitting element, the illumination device is omitted.

For example, a driver IC chip 5 and a flexible printed circuit 6 are connected to the display panel 2. The driver IC chip 5 controls the driving of the display panel 2.

An outside host computer H is connected to the display panel 2. The host computer H outputs image data corresponding to the image displayed in the display panel 2. The image displayed in the display panel 2 of the display device DSPL is an image for the left eye (or an image viewed by the left eye EL of the user). The image displayed in the display panel 2 of the display device DSPR is an image for the right eye (or an image viewed by the right eye ER of the user).

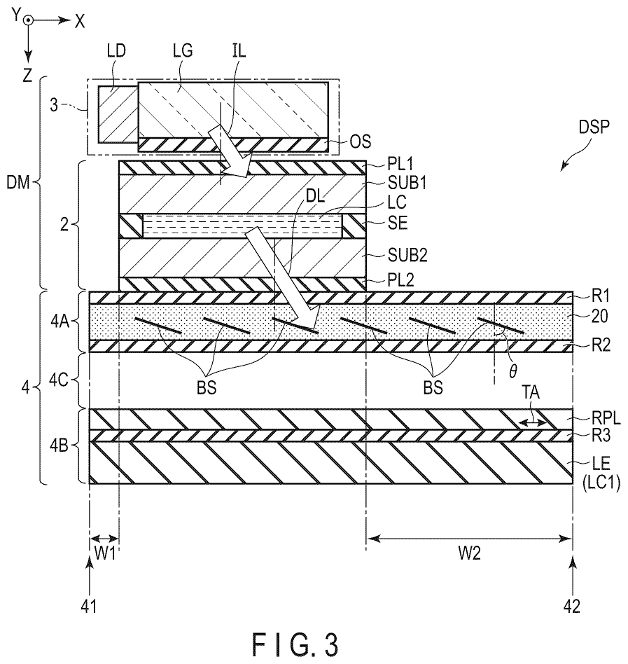

FIG. 3 is a cross-sectional view showing a configuration example of a display device DSP. The display device DSP explained here can be applied to each of the display devices DSPR and DSPL described above.

A display module DM comprises a display panel 2 and an illumination device 3.

The display panel 2 is a transmissive liquid crystal panel and is formed into a plate-like shape. The display panel 2 comprises a first substrate SUB1, a second substrate SUB2, a liquid crystal layer LC, a first polarizer PL1 and a second polarizer PL2. The liquid crystal layer LC is held between the first substrate SUB1 and the second substrate SUB2 in a third direction Z, and is sealed by a sealant SE. The first polarizer PL1 is provided between the illumination device 3 and the first substrate SUB1 in the third direction Z. The second polarizer PL2 is provided between the second substrate SUB2 and an optical system 4 in the third direction Z.

The illumination device 3 comprises a light emitting element LD, a light guide LG and an optical sheet OS. The light emitting element LD is provided so as to face a side surface of the light guide LG in a first direction X. The optical sheet OS is provided between the light guide LG and the display panel 2 in the third direction Z. The illumination device 3 is configured to emit illumination light IL in a direction which inclines with respect to the normal of the light guide LG.

In the display panel 2, illumination light IL from the illumination device 3 is selectively modulated in the liquid crystal layer LC, passes through the second polarizer PL2 and is converted into display light DL which is linearly polarized light. Display light DL is emitted in a direction which inclines with respect to the normal of the second substrate SUB2.

The optical system 4 comprises a first structure 4A and a second structure 4B. The first structure 4A is spaced apart from the second structure 4B in the third direction Z. An aerial layer 4C is interposed between the first structure 4A and the second structure 4B. The display panel 2 is provided between the illumination device 3 and the first structure 4A in the third direction Z. The first structure 4A is provided between the display panel 2 and the second structure 4B (or between the display panel 2 and the aerial layer 4C) in the third direction Z.

The first structure 4A comprises a first retardation film R1 facing the display module DM, a holographic optical element 20 facing the first retardation film R1, and a second retardation film R2 facing the holographic optical element 20. The holographic optical element 20 is located between the first retardation film R1 and the second retardation film R2 in the third direction Z. For example, the first retardation film R1, the holographic optical element 20 and the second retardation film R2 are stacked in this order in the third direction Z and attached to each other.

The second structure 4B comprises a reflective polarizer RPL facing the second retardation film R2, a third retardation film R3 facing the reflective polarizer RPL, and a lens element LE facing the third retardation film R3. The third retardation film R3 is located between the reflective polarizer RPL and the lens element LE in the third direction Z. For example, the reflective polarizer RPL, the third retardation film R3 and the lens element LE are stacked in this order and attached to each other in the third direction Z. The aerial layer 4C is interposed between the second retardation film R2 and the reflective polarizer RPL.

The first retardation film R1, the second retardation film R2 and the third retardation film R3 are quarter-wave plates and impart a quarter-wave phase difference to the light which passes through the retardation films.

The holographic optical element 20 has an interference pattern and has the refractive-index distribution of a pitch corresponding to a wavelength in the thickness direction. This holographic optical element 20 is configured to reflect and diffract part of the incident light in a predetermined direction. The holographic optical element 20 comprises Bragg surfaces (virtual reflective surfaces) BS which incline in the same direction on the whole surface. The angle θ made by each Bragg surface BS and the holographic optical element 20 is greater than 0° and less than 90°.

The holographic optical element 20 is configured to reflect incident light having a specific incident angle relative to the normal of each Bragg surface BS and transmit incident light having an incident angle which is different from the specific incident angle. The light which passes through the holographic optical element 20 is, for example, incident light having an incident angle of +10° or greater or −10° or less relative to the specific incident angle.

The reflective polarizer RPL comprises a transmission axis TA. Of the incident light, the reflective polarizer RPL is configured to reflect first linearly polarized light and transmit second linearly polarized light orthogonal to the first linearly polarized light.

As described in detail later, the lens element LE comprises a liquid crystal layer LC1. The liquid crystal layer LC1 is configured to impart a half-wave phase difference to light having a specific wavelength and have a lens effect of condensing first circularly polarized light and converting it into second circularly polarized light which rotates in the opposite direction of the first circularly polarized light. It should be noted that the element having a lens effect of condensing circularly polarized light is not limited to an element using a liquid crystal.

In the example shown in the figure, each element constituting the optical system 4 is formed so as to be wider than the display panel 2 in the first direction X. Each of the first retardation film R1, the holographic optical element 20, the second retardation film R2, the reflective polarizer RPL, the third retardation film R3 and the lens element LE comprises an end portion (a first end portion) 41 on the side on which the light emitting element LD is provided, and the other end portion (a second end portion) 42 on the side opposite to the end portion 41. Width W1 from the display panel 2 to the end portion 41 is less than width W2 from the display panel 2 to the other end portion 42 (W1<W2). Here, both width W1 and width W2 are lengths parallel to the first direction X. Both illumination light IL and display light DL are emitted in a direction toward the other end portion 42 of the optical system 4.

In FIG. 3, the end portion 41 is located on the left side of the figure relative to the display panel 2, and the other end portion 42 is located on the right side of the figure relative to the display panel 2. Illumination light IL and display light DL are emitted from top left toward bottom right in FIG. 3.

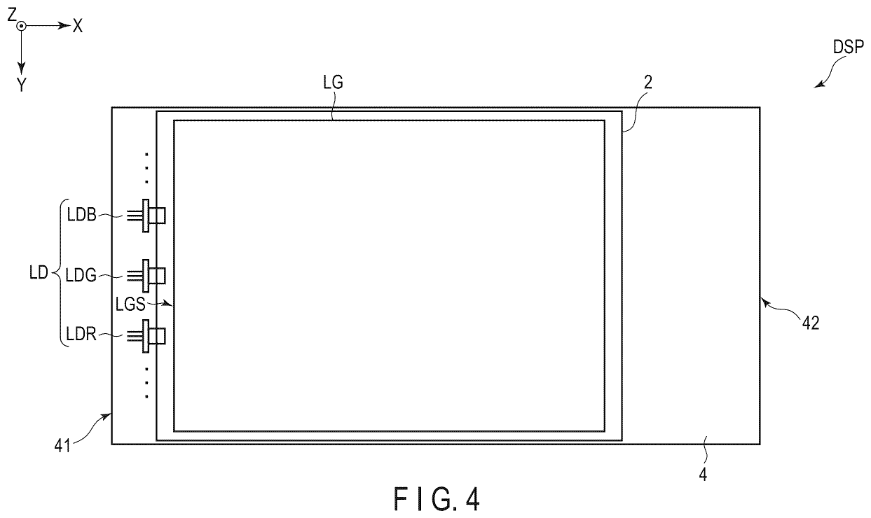

FIG. 4 is a plan view showing the display device DSP shown in FIG. 3.

A plurality of light emitting elements LD face a side surface LGS of the light guide LG. The light emitting elements LD include a first light emitting element LDB which emits light having a blue wavelength (first wavelength), a second light emitting element LDG which emits light having a green wavelength (second wavelength) and a third light emitting element LDR which emits light having a red wavelength (third wavelength). The first light emitting element LDB, the second light emitting element LDG and the third light emitting element LDR are arranged at intervals.

The emitted light from each light emitting element LD should preferably have a narrow spectral width (or a high color purity). Thus, as each light emitting element LD, a laser element should be preferably applied.

The display panel 2 overlaps the light guide LG.

The optical system 4 overlaps the display panel 2. The optical system 4 extends in a direction orthogonal to the side surface LGS of the light guide LG.

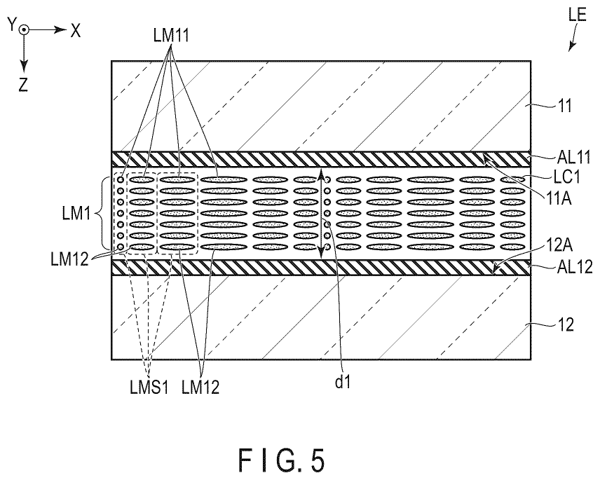

FIG. 5 is a cross-sectional view showing an example of the lens element LE shown in FIG. 3.

The lens element LE comprises a substrate 11, an alignment film AL11, the liquid crystal layer LC1, an alignment film AL12 and a substrate 12. The substrates 11 and 12 are transparent substrates which transmit light, and consist of, for example, a transparent glass plate or a transparent synthetic resinous plate.

The alignment film AL11 is provided on the inner surface 11A of the substrate 11. In the example shown in FIG. 5, the alignment film AL11 is in contact with the substrate 11. However, a thin film may be interposed between the alignment film AL11 and the substrate 11.

The alignment film AL12 is provided on the inner surface 12A of the substrate 12. In the example shown in FIG. 5, the alignment film AL12 is in contact with the substrate 12. However, a thin film may be interposed between the alignment film AL12 and the substrate 12. The alignment film AL12 faces the alignment film AL11 in the third direction Z.

The alignment films AL11 and AL12 are formed of, for example, polyimide, and are both horizontal alignment films having an alignment restriction force parallel to the X-Y plane.

The liquid crystal layer LC1 is provided between the alignment films AL11 and AL12, and is in contact with the alignment films AL11 and AL12. The liquid crystal layer LC1 has thickness d1 in the third direction Z. The liquid crystal layer LC1 comprises nematic liquid crystals in which the alignment direction parallel to the third direction Z is uniform.

In other words, the liquid crystal layer LC1 comprises a plurality of liquid crystal structures LMS1. When this specification focuses on a liquid crystal structure LMS1, the liquid crystal structure LMS1 comprises a liquid crystal molecule LM11 located at an end of the liquid crystal structure LMS1, and a liquid crystal molecule LM12 located at the other end. The liquid crystal molecule LM11 is close to the alignment film AL11, and the liquid crystal molecule LM12 is close to the alignment film AL12. The alignment direction of the liquid crystal molecule LM11 is substantially coincident with the alignment direction of the liquid crystal molecule LM12. The alignment direction of another liquid crystal molecule LM1 between the liquid crystal molecule LM11 and the liquid crystal molecule LM12 is also substantially coincident with the alignment direction of the liquid crystal molecule LM11. Here, the alignment direction of each liquid crystal molecule LM1 corresponds to the direction of the long axis of the liquid crystal molecule in the X-Y plane.

In the liquid crystal layer LC1, a plurality of liquid crystal structures LMS1 which are adjacent to each other in the first direction X have alignment directions different from each other. Similarly, a plurality of liquid crystal structures LMS1 which are adjacent to each other in a second direction Y have alignment directions different from each other. The alignment directions of the liquid crystal molecules LM11 arranged along the alignment film AL11 and the alignment directions of the liquid crystal molecules LM12 arranged along the alignment film AL12 successively (or linearly) change.

This liquid crystal layer LC1 is cured in a state where the alignment directions of the liquid crystal molecules LM1 including the liquid crystal molecules LM11 and the liquid crystal molecules LM12 are fixed. In other words, an electric field does not control the alignment directions of the liquid crystal molecules LM1. Thus, the lens element LE does not comprise an electrode for alignment control.

When the refractive anisotropy or double refraction property of the liquid crystal layer LC1 (the difference between refractive index ne for extraordinary light and refractive index no for ordinary light in the liquid crystal layer LC1) is defined as Δn, retardation (phase difference) Δn·d1 of the liquid crystal layer LC1 is set so as to be half a specific wavelength λ.

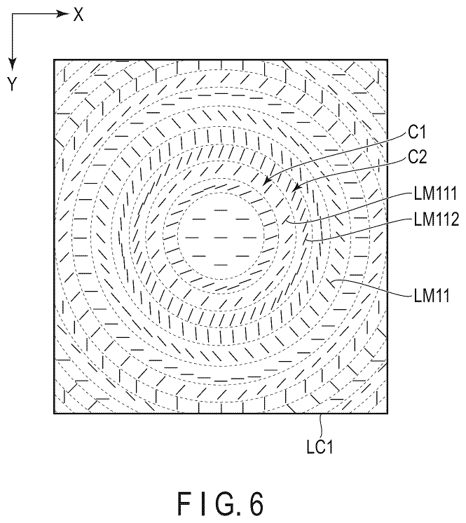

FIG. 6 is a plan view showing an example of the alignment pattern in the liquid crystal layer LC1 shown in FIG. 5.

FIG. 6 shows an example of a spacial phase in the X-Y plane of the liquid crystal layer LC1. Here, spacial phases are shown as the alignment directions of the liquid crystal molecules LM11 close to the alignment film AL11 among the liquid crystal molecules LM1 included in each liquid crystal structure LMS1.

In each concentric circle shown by a dotted line in the figure, the spacial phase is uniform. In an annular area surrounded by two adjacent concentric circles, the alignment directions of the liquid crystal molecules LM11 are uniform. However, between adjacent annular areas, the alignment directions of the liquid crystal molecules LM11 are different from each other.

For example, in plan view, the liquid crystal layer LC1 comprises a first annular area C1 and a second annular area C2. The second annular area C2 is located on the external side relative to the first annular area C1. The first annular area C1 consists of a plurality of first liquid crystal molecules LM111 aligned in the same direction. The second annular area C2 consists of a plurality of second liquid crystal molecules LM112 aligned in the same direction. The alignment direction of the first liquid crystal molecules LM111 is different from that of the second liquid crystal molecules LM112.

Similarly, the alignment directions of the liquid crystal molecules LM11 arranged in the radial direction from the area of the center of the concentric circles are different from each other and sequentially change. In other words, in the X-Y plane shown in the figure, the spacial phase of the liquid crystal layer LC1 differs in the radial direction and sequentially changes.

When the first circularly polarized light having the specific wavelength λ enters the lens element LE having the above configuration, the first circularly polarized light is condensed toward the center of the concentric circles, and further, the transmitted light of the lens element LE is converted into the second circularly polarized light which rotates in the opposite direction of the first circularly polarized light.

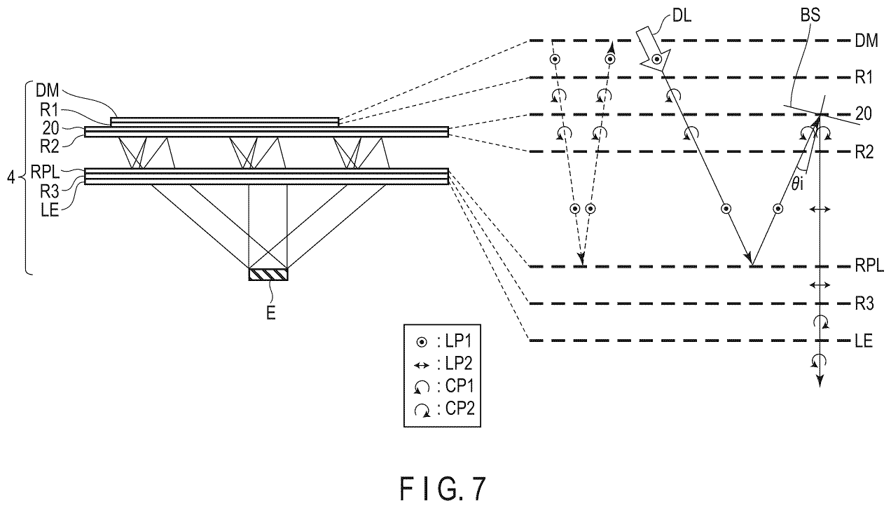

FIG. 7 is a diagram for explaining an example of the optical effect of the display device DSP shown in FIG. 3.

First, the display module DM emits display light DL which is first linearly polarized light LP1. Here, the first linearly polarized light LP1 is, for example, linearly polarized light which oscillates in a direction perpendicular to the drawing. The display light DL is emitted in an oblique direction toward the other end portion 42 of the optical system 4. The display light DL passes through the first retardation film R1 and is converted into first circularly polarized light CP1. Here, the first circularly polarized light CP1 is, for example, left-handed circularly polarized light.

The first circularly polarized light CP1 which passed through the first retardation film R1 passes through the holographic optical element 20. The first circularly polarized light CP1 which passed through the holographic optical element 20 passes through the second retardation film R2 and is converted into first linearly polarized light LP1.

The first linearly polarized light LP1 which passed through the second retardation film R2 is reflected on the reflective polarizer RPL. The first linearly polarized light LP1 which was reflected on the reflective polarizer RPL passes through the second retardation film R2 and is converted into first circularly polarized light CP1.

The first circularly polarized light CP1 which passed through the second retardation film R2 enters the holographic optical element 20 at a specific incident angle θi. Thus, the incident light is reflected and diffracted on the Bragg surfaces BS. When first circularly polarized light CP1 is reflected and diffracted on the holographic optical element 20, the light is converted into second circularly polarized light CP2. Here, the second circularly polarized light CP2 is, for example, right-handed circularly polarized light.

The second circularly polarized light CP2 which was reflected on the holographic optical element 20 passes through the second retardation film R2 and is converted into second linearly polarized light LP2. Here, the second linearly polarized light LP2 is, for example, linearly polarized light which oscillates in a direction parallel to the drawing.

The second linearly polarized light LP2 which passed through the second retardation film R2 passes through the reflective polarizer PRL. The second linearly polarized light LP2 which passed through the reflective polarizer PRL passes through the third retardation film R3 and is converted into second circularly polarized light CP2. The second circularly polarized light CP2 which passed through the third retardation film R3 is converted into first circularly polarized light CP1 in the lens element LE and is condensed to the eye E of the user by a lens effect.

It should be noted that the first linearly polarized light LP1 explained with reference to FIG. 7 may be replaced by the second linearly polarized light LP2, or the first circularly polarized light CP1 may be replaced by the second circularly polarized light CP2.

In the display device DSP comprising the above configuration, the optical system 4 comprises an optical path in which light passes through the portion between the holographic optical element 20 and the reflective polarizer RPL three times. Thus, in the optical system 4, the optical distance between the holographic optical element 20 and the reflective polarizer RPL is approximately three times the actual interval between the holographic optical element 20 and the reflective polarizer RPL. By this configuration, when an image displayed in the display module DM is regarded an object, the user can observe an enlarged virtual image of the object formed in the distance via the optical system 4.

To realize an optical path in which light passes through the portion between the holographic optical element 20 and the reflective polarizer RPL three times, it is important that the reflected light which is reflected on the reflective polarizer RPL enters the holographic optical element 20 at a specific incident angle θi. Thus, the display module DM needs to emit display light DL at a predetermined angle. To realize this configuration, the illumination device 3 of the display module DM is configured to emit illumination light IL at a predetermined angle.

Even if the light which is reflected on the reflective polarizer RPL partly passes through the holographic optical element 20, this undesired reflected light is reflected between the display module DM and the reflective polarizer RPL. Thus, the undesired reflected light is not observed by the user. In this manner, the reduction in display quality can be prevented.

In addition, compared to a case where the reflective polarizer RPL is replaced by a holographic optical element, the optical design is easy, and further, the cost can be reduced.

Moreover, the number of components constituting the optical system 4 is less, and thus, the number of interfaces between components is also less. In this manner, undesired reflection can be prevented.

Further, the holographic optical element 20 applied in the embodiment does not substantially include a lens effect and is configured to reflect light having a specific incident angle in a specific direction on the whole surface. Thus, compared to a holographic optical element having a lens effect, the holographic optical element 20 of the embodiment can be easily prepared, and the cost can be reduced.

In addition, compared to an optical system comprising an optical component formed of glass, resin, etc., the thickness in the third direction Z can be reduced, and the weight can be also decreased.

As explained above, the embodiment can provide a display device which can prevent the reduction in display quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display module configured to emit display light which is linearly polarized light;
a first retardation film which faces the display module;
a holographic optical element which faces the first retardation film and is configured to reflect first circularly polarized light having a specific incident angle and transmit light having an incident angle which is different from the specific incident angle;
a second retardation film which faces the holographic optical element;
a reflective polarizer which faces the second retardation film and is configured to reflect first linearly polarized light and transmit second linearly polarized light;
a third retardation film which faces the reflective polarizer; and
a lens element which faces the third retardation film and has a lens effect of condensing first circularly polarized light and converting first circularly polarized light into second circularly polarized light.

2. The display device of claim 1, wherein
the first retardation film, the holographic optical element and the second retardation film are stacked,
the reflective polarizer, the third retardation film and the lens element are stacked, and
an aerial layer is interposed between the second retardation film and the reflective polarizer.

3. The display device of claim 1, wherein
the holographic optical element comprises Bragg surfaces which incline in a same direction on a whole surface.

4. The display device of claim 1, wherein
the first retardation film, the second retardation film and the third retardation film are quarter-wave plates.

5. The display device of claim 1, wherein
the lens element comprises a liquid crystal layer which is cured in a state where alignment directions of a plurality of liquid crystal molecules are fixed,
the liquid crystal layer comprises, in plan view, a first annular area in which a plurality of first liquid crystal molecules are aligned in a same direction, and a second annular area in which a plurality of second liquid crystal molecules are aligned in a same direction on an external side relative to the first annular area, and
the alignment direction of the first liquid crystal molecules is different from the alignment direction of the second liquid crystal molecules.

6. The display device of claim 1, wherein
the display module comprises a display panel, and an illumination device provided on a back surface of the display panel, and
the illumination device comprises a light guide, and a plurality of light emitting elements facing a side surface of the light guide, and is configured to emit illumination light such that light which is reflected on the reflective polarizer enters the holographic optical element at the specific incident angle.

7. The display device of claim 6, wherein
the light emitting elements are laser elements.

8. The display device of claim 6, wherein
each of the first retardation film, the holographic optical element, the second retardation film, the reflective polarizer, the third retardation film and the lens element comprises a first end portion on a side on which the light emitting elements are provided, and a second end portion on an opposite side of the first end portion, and
a width from the display panel to the first end portion is less than a width from the display panel to the second end portion.
